(19) United States
(12) Patent Application Publication
(10) Pub. No.: US 2013/0343761 A1
(43) Pub. Date: Dec. 26, 2013

(54) Access Equipment that Runs Ethernet Passive Optical Network (PON) or Ethernet PON Over Coax Network

(71) Applicant: Futurewei Technologies, Inc., Plano, TX (US)

(72) Inventors: Liming Fang, Cupertino, CA (US); Jim Chen, Corona, CA (US); Li Zhang, Wuhan (CN)

(21) Appl. No.: 13/928,185

(22) Filed: Jun. 26, 2013

Related U.S. Application Data
(60) Provisional application No. 61/690,417, filed on Jun. 26, 2012.

(51) Int. Cl. H04B 10/27

(52) U.S. Cl. CPC H04B 10/271
USPC 398/115

(57) ABSTRACT

An optical line terminal (OLT) comprising an optical transmitter, and an optical port coupled to the optical transmitter, wherein the optical port is configured to couple to a hybrid fiber coaxial (HFC) node via an optical fiber, and wherein the optical transmitter is configured to transmit analog signals to the HFC node via the optical fiber. Also included is a coaxial line terminal (CLT) comprising an electrical transmitter, and an electrical port coupled to the electrical transmitter, wherein the electrical port is configured to couple to a coaxial network unit (CNU) via an electrical cable, and wherein the electrical transmitter is configured to transmit radio frequency (RF) signals to the CNU via the electrical cable.

### CROSS-REFERENCE TO RELATED APPLICATIONS

The present application claims the benefit of U.S. Provisional Patent Application No. 61/690,417 filed Jun. 26, 2012 by Liming Fang, et al. and entitled “Method and Apparatus of Building an Access Equipment to Run Ethernet Passive Optical Network (PON) or Ethernet PON Over Coax Network” which is incorporated herein by reference as if reproduced in its entirety.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

Ethernet PON (EPON) is a Passive Optical Network (PON) standard developed by the Institute of Electrical and Electronics Engineers (IEEE) and specified in IEEE 802.3ah. It provides a simple and flexible way of using optical fiber as last mile broadband service. Different Ethernet over Coax (EoC) technologies including Multimedia over Coax Alliance (MoCA), G.hn, Home PNA Alliance (HPNA), and Home Plug audio/visual (AN) used as in home transmission have been adapted to run the outdoor coax access from Optical Network Unit (ONU) to EoC Head End with connected Customer Premises Equipment (CPEs) located in the subscriber homes. However, none of these technologies integrates with the same EPON platform to run from the Optical Line Terminal (OLT) to ONU or from the OLT to Coax Network Unit (CNU).

### SUMMARY

In one embodiment, the disclosure includes an optical line terminal (OLT) comprising an optical transmitter, and an optical port coupled to the optical transmitter, wherein the optical port is configured to couple to a hybrid fiber coaxial (HFC) node via an optical fiber, and wherein the optical transmitter is configured to transmit analog signals to the HFC node via the optical fiber.

In another embodiment, the disclosure includes a coaxial line terminal (CLT) comprising an electrical transmitter, and an electrical port coupled to the electrical transmitter, wherein the electrical port is configured to couple to a coaxial network unit (CNU) via an electrical cable, and wherein the electrical transmitter is configured to transmit radio frequency (RF) signals to the CNU via the electrical cable.

In another embodiment, the disclosure includes a method comprising identifying a passive optical network (PON) optical line terminal (OLT), and adding a PON over coax (PoC) line card to the OLT so that the OLT communicates with a hybrid fiber coaxial (HFC) node and coaxial network units (CNUs) within the PoC network via amplitude modulated (AM) signals.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram of unified optical-coaxial networks according to embodiments of the disclosure.

FIG. 2 is a schematic diagram of an embodiment of the coax convergence layer protocol stack.

FIG. 3 is a schematic diagram of an embodiment of the control layers within the OLT, the Coax Media Converter (CMC), and the CNU.

FIG. 4 is a schematic diagram of an embodiment of the data link and physical (PHY) layers within the CLT and the CNU.

FIG. 5 is a schematic diagram of one embodiment of the integration of an EPON media access control (MAC) with an Ethernet PoC (EPoC) PHY.

FIG. 6 is a schematic diagram of one embodiment of the connectivity between the OLT, the ONUs, the HFC, and the CNUs.

FIG. 7 is a schematic diagram of one embodiment of the EPON OLT PHY and MAC layers.

FIG. 8 is a flowchart of one embodiment of an EPON upgrade method

FIG. 9 is a schematic diagram of an embodiment of a network element.

### DETAILED DESCRIPTION

It should be understood at the outset that, although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

An EPoC system is a hybrid access network employing both optical and coaxial technologies. An EPoC system comprises two segments: an optical segment that is essentially a PON, and a coaxial segment that is a coaxial cable network. In the PON segment, an OLT resides in the local exchange or central office where the OLT connects the EPoC access network to an Internet Protocol (IP) backbone. In the coaxial segment, CNUs may lie at the end-user locations, and each CNU typically serves three to four end users which are also known as subscribers. A CMC merges the interface between the PON segment and the coaxial segment of the network. The CMC is a single box unit that may be located where an ONU and a CLT are fused together, typically at the curb or at the basement of an apartment building. Hence, the CMC is responsible for handling the end-to-end fiber to coaxial upstream and downstream transmissions.

Some EPoC embodiments include a packet repeater operating in Frequency Division Duplex (FDD) mode and/or a bridge based architecture in Time Division Duplex (TDD) mode. In the packet repeater architecture, EPON frames are passed through from EPON PHY to EPoC PHY with no internal burst buffers at the CMC. Hence, this architecture cannot support burst repeater functions. In the bridge based architecture, the CMC comprises two complete media access controls (MACs), an EPON MAC and an EPoC MAC where an EPoC scheduler manages the EPON to EPoC quality of service (QoS) or service level agreement (SLA). The drawbacks of this architecture are higher delay due to the two stages scheduling and higher management overhead.

The disclosed embodiments improve on prior EPoC systems by moving the functionality of the CMC/Hybrid Fiber Coaxial (HFC) node to the OLT/coax line terminal (CLT). In some embodiments, the OLT/CLT communicates with the CMC/HFC node via optical fiber using amplitude modulated (AM)/analog signals. In other embodiments, the CLT can transmit electrical (coax) signals, which are converted to optical signals, optionally multiplexed with other signals, and sent to the CMC/HFC node via the optical fiber. Doing so reduces the complexity of the intermediate CMC/HFC node, perhaps eliminating all functionality with the exception of the optical-electrical (O-E) and electrical-optical (E-O) conversion at the physical (PHY) layer.

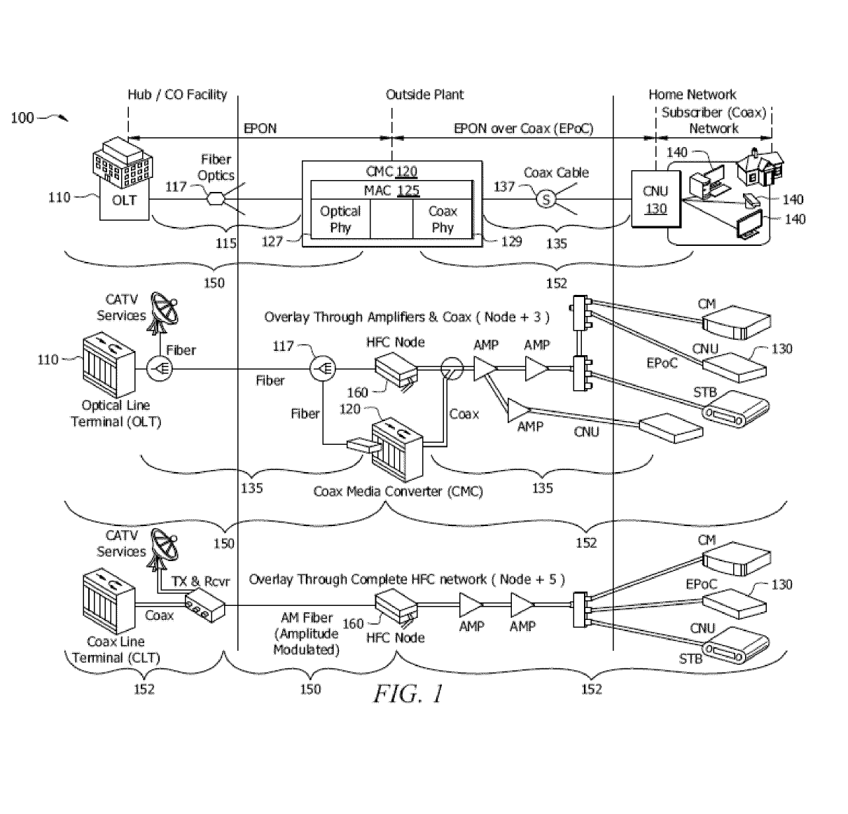

FIG. 1 illustrates three embodiments of a unified optical-coaxial network 100 comprising an optical portion 150 and a coaxial (electrical) portion 152. The unified optical-coaxial network 100 may include an OLT 110, at least one CNU 130 coupled to a plurality of subscriber devices 140, and a CMC 120 positioned between the OLT 110 and the CNU 130, e.g., between the optical portion 150 and the coaxial portion 152. The OLT 110 may be coupled via an Optical Distribution Network (ODN) 115 to the coax media converters (CMCs) 120, and optionally to one or more ONUs (not shown), or one or more HFC nodes 160 in the optical portion 150. The ODN 115 may comprise fiber optics and an optical splitter 117 or a cascade of 1×M passive optical splitters that couples OLT 110 to the CMC 120 and any ONUs. The value of M in EPoC, i.e., the number of CMCs, is typically 4, 8, or 16, and is decided by the operator depending on factors such as optical power budget. The CMC 120 may be coupled to the CNUs 130 via an electrical distribution network (EDN) 135, which may comprise a cable splitter 137 or a cascade of taps/splitters, or one or more amplifiers. Each OLT port can typically serve 32, 64, 128, or 256 CNUs. It should be noted that the upstream transmissions from CNUs may only reach the CMC and not the other CNUs due to the directional property of the tap. The distances between the OLT and the ONUs are in the range of 10 to 20 kilometers, and the distances between the CMC and CNUs are in the range of 100 to 500 meters. The unified optical-coaxial network 100 may comprise any number of HFCs 160, CMCs 120, and corresponding CNUs 130. The components of unified optical-coaxial network 100 may be arranged as shown in FIG. 1 or any other suitable arrangement.

The optical portion 150 of the unified optical-coaxial network 100 may be similar to a PON in that it may be a communications network that does not require any active components to distribute data between the OLT 110 and the CMC 120. Instead, the optical portion 150 may use the passive optical components in the ODN 115 to distribute data between the OLT 110 and the CMC 120. Examples of suitable protocols that may be implemented in the optical portion 150 include the asynchronous transfer mode PON (APON), the broadband PON (BPON) defined by the International Telecommunication Union (ITU) Telecommunication Standardization Sector (ITU-T) G.983 standard, Gigabit PON (GPON) defined by the ITU-T G.984 standard, the EPON defined by the IEEE 802.3ah and 802.3av standards, and the wavelength division multiplexing (WDM) PON (WDM-PON), all of which are incorporated by reference as if reproduced in their entirety.

The OLT 110 may be any device configured to communicate with the CNUs 130 via the CMC 120. The OLT 110 may act as an intermediary between the CMCs 120 or CNUs 130 and another network (not shown). The OLT 110 may forward data received from the other network to the CMCs 120 or CNUs 130 and forward data received from the CMCs 120 or CNUs 130 onto the other network. Although the specific configuration of the OLT 110 may vary depending on the type of optical protocol implemented in the optical portion 150, in an embodiment, OLT 110 may comprise an optical transmitter and an optical receiver. When the other network is using a network protocol that is different from the protocol used in the optical portion 150, OLT 110 may comprise a converter that converts the other network protocol into the optical portion 150 protocol. The OLT converter may also convert the optical portion 150 protocol into the other network protocol. In some instances, an OLT may be referred to as a CLT or fiber coaxial unit (FCU), particularly when the connection to the HFC node contains coax cables, as shown in the bottom row of FIG. 1.

The ODN 115 may be a data distribution system that may comprise optical fiber cables, couplers, splitters, distributors, and/or other equipment. In an embodiment, the optical fiber cables, couplers, splitters, distributors, and/or other equipment are passive optical components. Specifically, the optical fiber cables, couplers, splitters, distributors, and/or other equipment may be components that do not require any power to distribute data signals between the OLT 110 and the CMC 120. It should be noted that the optical fiber cables may be replaced by any optical transmission media in some embodiments. In some embodiments, the ODN 115 may comprise one or more optical amplifiers. The ODN 115 typically extends from the OLT 110 to the CMC 120 and any optional ONUs (not shown) in a branching configuration as shown in FIG. 1, but may be alternatively configured as determined by a person of ordinary skill in the art.

The CMC 120 may be any device or component configured to forward downstream data from the OLT 110 to the corresponding CNUs 130 and forward upstream data from the CNUs 130 to the OLT 110. The CMC 120 may convert the downstream and upstream data appropriately to transfer the data between the optical portion 150 and the coaxial portion 152. The data transferred over the ODN 115 may be transmitted or received in the form of optical signals, and the data transferred over the EDN 135 may be transmitted or received in the form of electrical signals that may have the same or different logical structure as compared with the optical signals. As such, the CMC 120 may encapsulate or frame the data in the optical portion 150 and the coaxial portion 152 differently. In an embodiment, the CMC 120 includes a MAC layer 125 and PHY layers, corresponding to the type of signals carried over the respective media. The MAC layer 125 may provide addressing and channel access control services to the PHY layers. As such, the PHY may comprise an optical PHY 127 and a coaxial PHY 129. In many embodiments, the CMC 120 is transparent to the CNU 130 and OLT 110 in that the frames sent from the OLT 110 to the CNU 130 may be directly addressed to the CNU 130 (e.g. in the destination address), and vice-versa. As such, the CMC 120 intermediates between network portions, namely an optical portion 150 and a coaxial portion 152 in the example of FIG. 1. As discussed further below, an identifier may be associated with each CMC 120, and the identifier may uniquely identify the each CMC 120. HFCs 160 and optical converter units (OCUs), not shown, are similar to CMCs 120, and thus the terms are used interchangeably herein

The electrical portion 152 of the unified electrical and coaxial network 100 may be similar to any known electrical communication system. The electrical portion 152 may not require any active components to distribute data between the CMC 120 and the CNU 130. Instead, the electrical portion 152 may use the passive electrical components in the electrical portion 152 to distribute data between the CMC 120 and the CNUs 130. Alternatively, the electrical portion 152 could use some active components, such as amplifiers. Examples of suitable protocols that may be implemented in the electrical portion 152 include MoCA, G.hn, HPNA, and Home Plug A/V, all of which are incorporated by reference as if reproduced in their entirety.

The EDN 135 may be a data distribution system that may comprise electrical cables (e.g. coaxial cable, twisted wires, etc.), couplers, splitters, distributors, and/or other equipment. In an embodiment, the electrical cables, couplers, splitters, distributors, and/or other equipment are passive electrical components. Specifically, the electrical cables, couplers, splitters, distributors, and/or other equipment may be components that do not require any power to distribute data signals between the CMC 120 and the CNU 130. It should be noted that the electrical cables may be replaced by any electrical transmission media in some embodiments. In some embodiments, the EDN 135 may comprise one or more electrical amplifiers. The EDN 135 typically extends from the CMC 120 to the CNU 130 in a branching configuration as shown in FIG. 1, but may be alternatively configured as determined by a person of ordinary skill in the art.

In an embodiment, the CNUs 130 may be any devices that are configured to communicate with the OLT 110, the CMC 120, and any subscriber devices 140. Specifically, the CNUs 130 may act as an intermediary between the CMC 120 and the subscriber devices 140. For instance, the CNUs 130 may forward data received from the CMC 120 to the subscriber devices 140, and forward data received from the subscriber devices 140 on to the OLT 110. Although the specific configuration of the CNUs 130 may vary depending on the type of unified optical-coaxial network 100, in an embodiment the CNUs 130 may comprise an electrical transmitter configured to send electrical signals to the CMC 120 and an electrical receiver configured to receive electrical signals from the CMC 120. Additionally, the CNUs 130 may comprise a converter that converts the electrical signal into electrical signals for the subscriber devices 140, such as signals in IEEE 802.11 wireless local area network (WiFi) protocol, and a second transmitter and/or receiver that may send and/or receive the electrical signals to the subscriber devices 140. In some embodiments, CNUs 130 and coaxial network terminals (CNTs) are similar, and thus the terms are used interchangeably herein. The CNUs 130 may be typically located at distributed locations, such as the customer premises, but may be located at other locations as well.

The subscriber devices 140 may be any devices configured to interface with a user or a user device. For example, the subscribed devices 140 may include desktop computers, laptop computers, tablets, mobile telephones, residential gateways, televisions, set-top boxes, and similar devices.

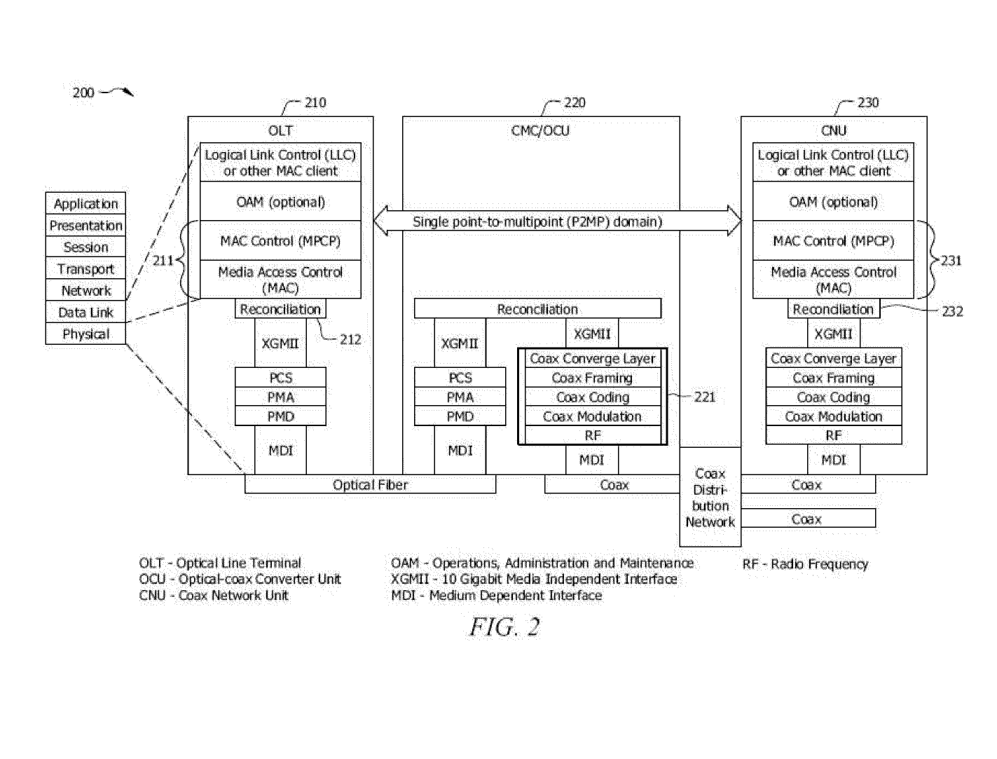

FIG. 2 is a diagram illustrating one embodiment of the EPoC protocol stack 200 in an EPON OLT 210, a CMC/optical coax unit (OCU)/FCU 220, and a CNU 230, which are similar to the OLT, CMC, and CNU. The EPON MAC layer and its associated sublayers from IEEE 802.3av may be the same without any modifications for EPoC. The disclosed embodiments introduce a coax convergence layer for EPoC PHY that can work closely with EPON MAC to complete an end-to-end transmission between EPON fiber network and EPoC coax network. Consequently, the CMC or OCU may be designed to be a PHY layer converter, which does not contain the data link layer.

Many of the elements of protocol stack 200 are as described in IEEE 802.3av, which is incorporated herein by reference as if reproduced in its entirety, so only the differences and notable items are discussed herein. In protocol stack 200, the Ethernet MAC, the EPON MAC, and the EPON multipoint control protocol (MPCP) as shown in 211 and 231 are used and are the same as IEEE 802.3ay. All MPCP functions are extended from the OLT to the CNU with the design of the proposed coax convergence layer. For example, the EPON link layer identifier (LLID) is directly assigned to each CNU by the OLT in the same way as to an ONU. The reconciliation sublayer 212 in the OLT 210 is also the same, while the reconciliation sublayer 232 in the CNU 230 is the same as the ONUs in IEEE 802.3ay. In protocol stack 200, the EPoC PHY sub-system 221 comprises a proposed coax convergence layer and a coax PHY stack, wherein the coax PHY stack further comprises a coax framing layer, a coax coding layer, a coax modulation layer, and a radio frequency (RF) layer, which provides the transmission channel. The coax framing layer decomposes and assembles data packets in the coax network according to the coax PHY modulation method. The coax coding layer protects the data transmission from impairments, such as impulse noise and variations in plant conditions. The coax modulation layer modulates the data according to the coax PHY modulation method. The RF layer interfaces to an electrical medium for a coaxial network. The PHY stack also performs channel estimation, sounding, registration, ranging, and other PHY layer functions for the coax channel. The coax convergence layer acts as the mediator between the optical and the coaxial domains. MPCP control messages and Ethernet data frames are transferred between the coax convergence layer and the EPON reconciliation sub-layer. These protocol layers are also present in the CNU 230 and operate similarly.

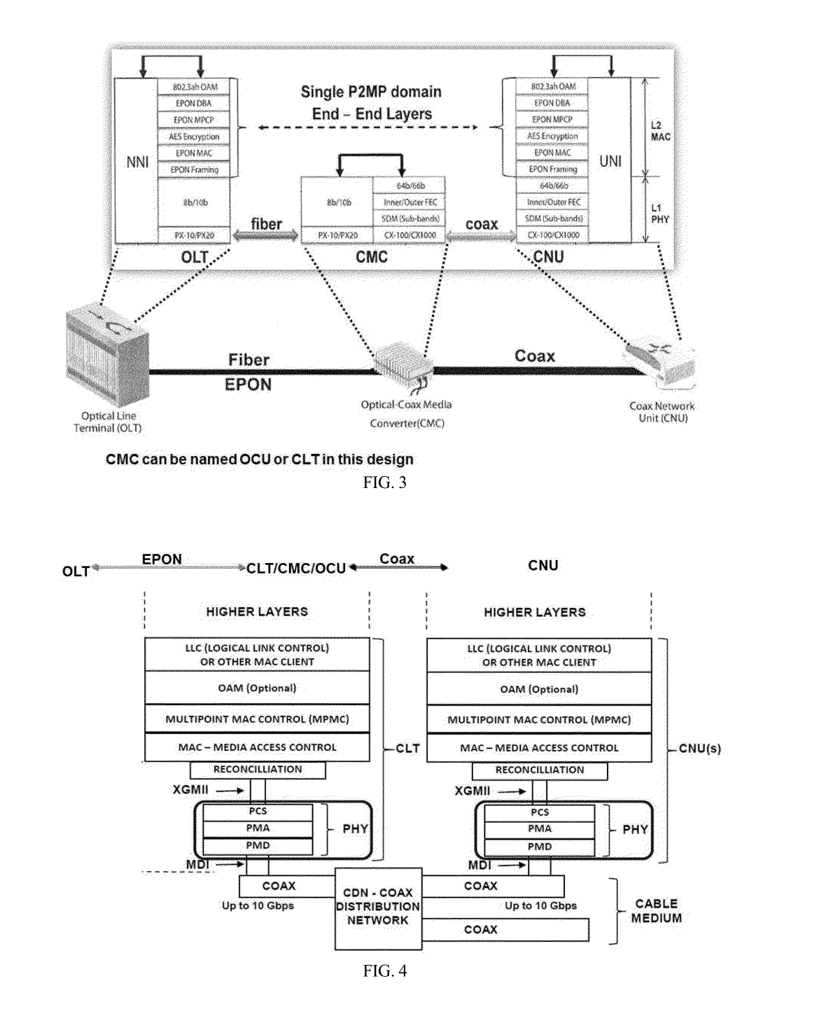

FIG. 3 is a diagram of one embodiment of the protocol layers within the OLT, the CMC, and the CNU. Within the OLT and the CNU, there may be similar layer 2 MAC sublayers, but differing layer 1 PHY sublayers. The layer 2 MAC sublayers may comprise an IEEE 802.3ah Operations, Administration, and Maintenance (OAM) sublayer, an EPON Dynamic Bandwidth Allocation (DBA) sublayer, an EPON MPCP sublayer, an Advanced Encryption Standard (AES) Encryption sublayer, an Ethernet MAC sublayer, and an EPON framing sublayer. These layer 2 MAC sublayers allow the OLT and the CNU to communicate with each other. The EPON MPCP sublayer performs the bandwidth assignment, bandwidth polling, auto-discovery, and ranging. The Ethernet MAC sublayer controls the placement and removal of frames from the media, the initiation of frame transmission, and recovery from transmission failure. The OLT's and CMC's PHY (8 bit (b)/10b and PX-10/PX-20 sublayers) designed to communicate over a fiber network, while the CMC's and CNU's PHY (64b/66b, Inner/outer forward error correction (FEC), space division multiplexing (SDM), and CX-100/CX-1000 sublayers) is designed to communicate over a coax network. In order to reconcile the two different PHYs, a CMC may be used to convert the optical signal from the fiber network into an electrical signal for the coax network and the electrical signal from the coax network into an optical signal for the fiber network. The CMC may be named an OCU or a CLT in the embodiment shown in FIG. 3. All of these sublayers interface through the network node interface (NNI) or user network interface (UNI). All of the sublayers in FIG. 3 are as described in the IEEE documents, e.g. IEEE 802.3av and 802.3ah.

FIG. 4 is a diagram of another embodiment of the protocol layers within the CLT/CMC/OCU and the CNU. The CLT/CMC/OCU's data link layers comprise a Logical Link Control (LLC) or other MAC client sublayer, the optional OAM sublayer, the multipoint MAC control (MPMC) sublayer, the MAC sublayer, and the reconciliation sublayer, as well as a 10 Gigabit Media Independent Interface (XGMII) layer. The LLC sublayer provides multiplexing mechanisms that allow multiple network protocols to coexist within a multipoint network and be transported over the same network medium. The LLC sublayer also acts as an interface between the MAC sublayer and the network layer. The MPMC sublayer performs the bandwidth assignment, bandwidth polling, auto-discovery, and ranging. The MAC sublayer provides addressing and channel access control mechanisms that make it possible for several terminals or network nodes to communicate within a multiple access network that incorporates a shared medium, such as Ethernet. The MAC sublayer acts as an interface between the LLC sublayer and the PHY layer and emulates a full-duplex logical communication channel in a multi-point network, providing unicast, multicast and broadcast communication services. The reconciliation sublayer processes PHY Local/Remote Fault messages and handles double data rate conversions. The XGMII layer is defined by the IEEE 802.3 for connecting full duplex 10 Gigabit Ethernet ports to each other and to other electronic devices on a printed circuit board, allowing the CLT/CMC/OCU to communicate with the CNU at speeds of up to 10 gigabits per second (Gbps) over the coax distribution network.

The PHY layers of the CLT/CMC/OCU comprise a physical coding sublayer (PCS), a physical medium attachment (PMA) sublayer, and a physical medium dependent (PMD) sublayer. The PCS performs auto-negotiation and coding such as 8b/10b encoding. The PMA sublayer performs PMA framing and octet synchronization/detection. The PMD sublayer comprises a transceiver for the physical medium. The CNU may use a similar PHY, allowing the CLT/CMC/OCU and the CNU to communicate. The EPON OLT may communicate with the CNU through the CLT/CMC/OCU, which converts the optical signal over the EPON network to an electrical signal for the Coax network.

FIG. 5 depicts one embodiment of the integration of an EPON MAC with an EPoC PHY. The CLT/CMC/OCU may use an EPON MAC chip in an OLT EPON line card to connect directly to the EPoC PHY over the coax distribution network (e.g. a new EPoC line card installed in an existing PON OLT). In some cases, the EPON PHY may be removed from the OLT EPON line card as well as the ONU optical PHY, leaving an EPON MAC and an EPoC PHY that provides both EPON optical and EPoC coax interface from the same OLT equipment.

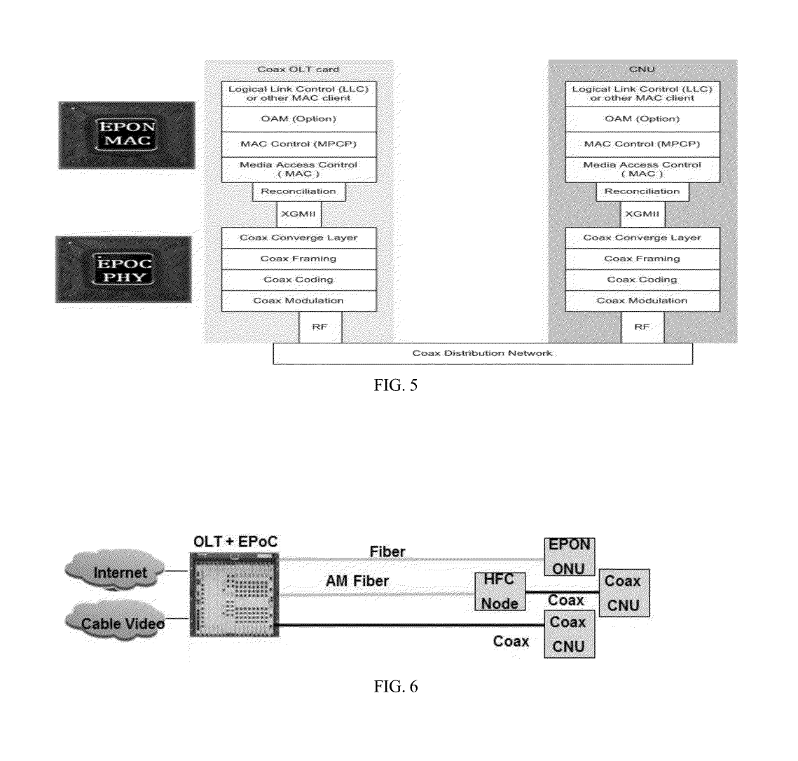

Installing the line card shown in FIG. 5 in the OLT may allow the OLT to communicate over multiple different physical communication mediums. FIG. 6 depicts the OLT inside the central office that has three modes of travel for the signal: fiber, amplitude modulated (AM)/analog fiber, and a purely coaxial/electrical line. The EPON MPCP and the EPON MAC may be applied to operate either the EPON OLT optical PHY or the EPoC coax PHY. The EPON reconciliation sub-layer may be designed in the OLT to run on either the EPON PHY or the EPoC PHY. The versatility to use either the EPON or EPoC PHY allows the OLT to communicate with EPON ONUs through a fiber and with EPoC CNUs through an AM fiber via an HFC node and a length of coaxial cable or directly through a coaxial cable.

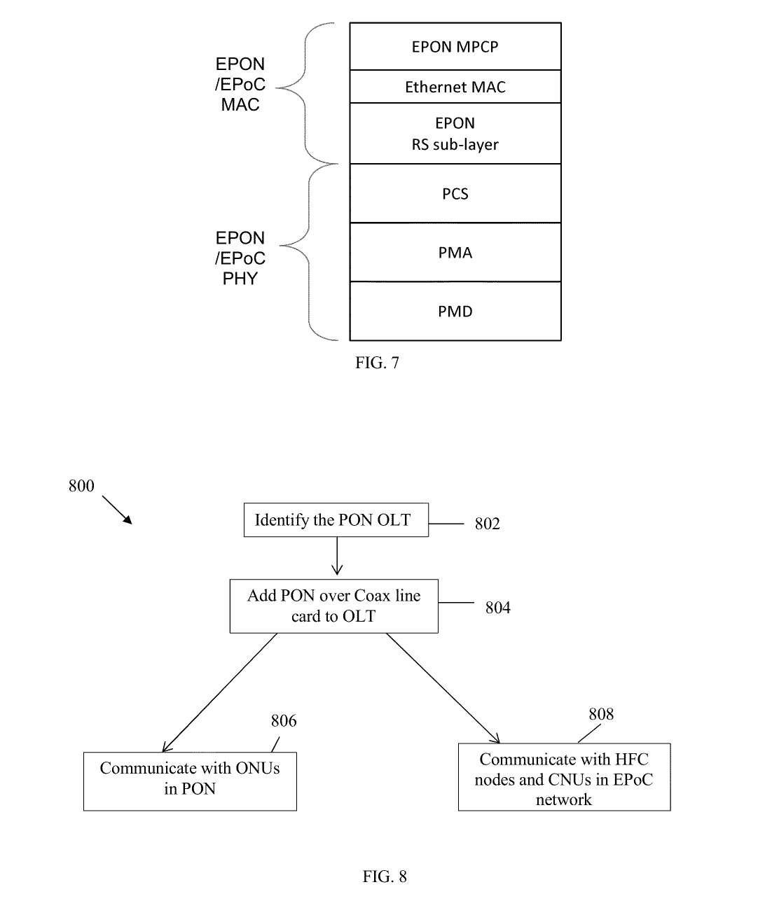

FIG. 7 depicts an embodiment of the protocol layers in the OLT in FIG. 6. The EPON MAC control comprises the EPON MPCP, the Ethernet MAC, and the EPON RS sublayer, which are the same as described above. The EPON reconciliation sub-layer in the OLT provides the interface to the EPoC PHY, which comprises the PCS, PMA, and PMD, all of which are the same as described above.

FIG. 8 depicts a flowchart of the EPON upgrade method 800. Method 800 may be implemented by a central office technician, e.g., when the OLT needs to be upgraded to support both EPON and EPoC networks as discussed above. At block 802, the PON OLT that must communicate with both PON and EPoC networks is identified. At block 804, a PON over coax (PoC), e.g. EPoC line cart is added to the OLT. At block 806, the OLT is released to allow communication with the PON, and at block 808, the OLT is released to allow communication with the PON.

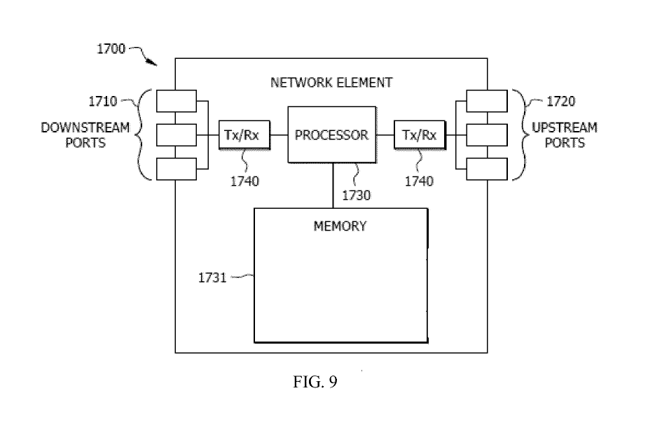

At least some of the features/methods described in the disclosure may be implemented in a network element. For instance, the features/methods in the disclosure may be implemented using hardware, firmware, and/or software installed to run on hardware. The network element may be any device that transports data through a network, e.g., a switch, router, bridge, server, client, etc. FIG. 9 is a schematic diagram of an embodiment of a network element 1700, which may be any device that transports and processes data through a network. For instance, the network element 1700 may be a CMC implanting one of the schemes described herein. The network element 1700 may be configured to implement or support the MPCP gate translation and downlink map (DL-MAP) generation methods described above.

The network element 1700 may comprise one or more downstream ports 1710 coupled to a transceiver (Tx/Rx) 1740, which may be transmitters, receivers, or combinations thereof. The Tx/Rx 1740 may transmit and/or receive frames from other nodes via the downstream ports 1710. Similarly, the network element 1700 may comprise another Tx/Rx 1740 coupled to plurality of upstream ports 1720, wherein the Tx/Rx 1740 may transmit and/or receive frames from other nodes via the upstream ports 1720. A processor 1730 may be coupled to the Tx/Rxs 1740 and be configured to process the frames and/or determine which nodes to send the frames. The processor 1730 may comprise one or more multi-core processors and/or memory modules 1731, which may function as data stores, buffers, etc. Processor 1730 may be implemented as a general processor or may be part of one or more application specific integrated circuits (ASICs) and/or digital signal processors (DSPs). The downstream ports 1710 and/or upstream ports 1720 may contain electrical and/or optical transmitting and/or receiving components. Network element 1700 may or may not be a routing component that makes routing decisions. The memory modules 1731 may be used to house the instructions for carrying out the system and methods described herein, e.g., the various protocol layers in the OLT 110, CMC 120, CNU 130, etc. The instructions stored in the memory module 1731 may be executed by the processor 1730. Alternately, the instructions stored in the memory module 1731 may be implemented directly on the processor 1730. Thus, the instructions stored in the memory module 1731 may be implemented using software, hardware, or both. The memory module 1731 may comprise a cache for temporarily storing content, e.g., a Random Access Memory (RAM). Additionally, the memory module 1731 may comprise a long-term storage for storing content relatively longer, e.g., a Read Only Memory (ROM). For instance, the cache and the long-term storage may include dynamic random-access memories (DRAMs), solid-state drives (SSDs), hard disks, or combinations thereof.

It is understood that by programming and/or loading executable instructions onto the network element 1700, at least one of the processor 1730, the cache, and the long-term storage are changed, transforming the network element 1700 in part into a particular machine or apparatus, e.g., a multi-core forwarding architecture, having the novel functionality taught by the present disclosure. It is fundamental to the electrical engineering and software engineering arts that functionality that can be implemented by loading executable software into a computer can be converted to a hardware implementation by well-known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware, for example in an ASIC, because for large production runs the hardware implementation may be less expensive than the software implementation. Often a design may be developed and tested in a software form and later transformed, by well-known design rules, to an equivalent hardware implementation in an application specific integrated circuit that hardwires the instructions of the software. In the same manner as a machine controlled by a new ASIC is a particular machine or apparatus, likewise a computer that has been programmed and/or loaded with executable instructions may be viewed as a particular machine or apparatus.

At least one embodiment is disclosed and variations, combinations, and/or modifications of the embodiment(s) and/or features of the embodiment(s) made by a person having ordinary skill in the art are within the scope of the disclosure. Alternative embodiments that result from combining, integrating, and/or omitting features of the embodiment(s) are also within the scope of the disclosure. Where numerical ranges or limitations are expressly stated, such express ranges or limitations may be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, Rₗ, and an upper limit, Rᵤ, is disclosed, any number falling within the range is specifically disclosed. In particular, the following numbers within the range are specifically disclosed: R=Rₗ+k*(Rᵤ−Rₗ), wherein k is a variable ranging from 1 percent to 100 percent with a 1 percent increment, i.e., k is 1 percent, 2 percent, 3 percent, 4 percent, 5 percent, . . . , 50 percent, 51 percent, 52 percent, . . . , 95 percent, 96 percent, 97 percent, 98 percent, 99 percent, or 100 percent. Moreover, any numerical range defined by two R numbers as defined in the above is also specifically disclosed. The use of the term “about” means +/−10% of the subsequent number, unless otherwise stated. Use of the term “optionally” with respect to any element of a claim means that the element is required, or alternatively, the element is not required, both alternatives being within the scope of the claim. Use of broader terms such as comprises, includes, and having may be understood to provide support for narrower terms such as consisting of, consisting essentially of, and comprised substantially of. Accordingly, the scope of protection is not limited by the description set out above but is defined by the claims that follow, that scope including all equivalents of the subject matter of the claims. Each and every claim is incorporated as further disclosure into the specification and the claims are embodiment(s) of the present disclosure. The discussion of a reference in the disclosure is not an admission that it is prior art, especially any reference that has a publication date after the priority date of this application. The disclosure of all patents, patent applications, and publications cited in the disclosure are hereby incorporated by reference, to the extent that they provide exemplary, procedural, or other details supplementary to the disclosure.

While several embodiments have been provided in the present disclosure, it may be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and may be made without departing from the spirit and scope disclosed herein.

What is claimed is:

1. An optical line terminal (OLT) comprising:
an optical transmitter; and
an optical port coupled to the optical transmitter, wherein the optical port is configured to couple to a hybrid fiber coaxial (HFC) node via an optical fiber, and
wherein the optical transmitter is configured to transmit analog signals to the HFC node via the optical fiber.

2. The OLT of claim 1, further comprising a processor coupled to the optical transmitter, wherein the processor comprises or is configured to execute an Ethernet passive optical network over coax (EPoC) media access control (MAC) layer configured to compose frames destined for the HFC node, wherein the EPoC MAC layer comprises:
an Ethernet passive optical network (EPON) multipoint control protocol (MPCP) sublayer;
an Ethernet MAC sublayer located logically under the EPON MPCP sublayer; and
an EPON reconciliation sublayer (RS) located logically under the Ethernet MAC sublayer.

3. The OLT of claim 2, wherein the processor further comprises or is configured to execute a physical (PHY) layer also configured to compose the frames destined for the HFC node, wherein the PHY layer comprises:
a physical coding sublayer (PCS);
a physical-medium-attachment (PMA) sublayer located logically under the PCS; and
a physical medium dependent (PMD) sublayer located logically under the PMA sublayer.

4. The OLT of claim 3, wherein the OLT further comprises:
a second optical transmitter; and
a second optical port coupled to the second optical transmitter,
wherein the second optical port is configured to couple to an optical network unit (ONU) via a second optical fiber, and
wherein the second optical transmitter is configured to transmit digital optical signals to the ONU via the second optical fiber.

5. The OLT of claim 4, wherein the processor further comprises or is configured to execute an Ethernet passive optical network (EPON) MAC layer configured to compose second frames destined for the ONU, wherein the EPON MAC layer comprises a second EPON MPCP sublayer and a second Ethernet MAC sublayer located logically under the second EPON MPCP sublayer, wherein the processor further comprises or is configured to execute a second PHY layer also configured to compose the second frames destined for the ONU, and wherein the second PHY layer comprises:
a second PCS;
a second PMA sublayer located logically under the second PCS; and
a second PMD sublayer located logically under the second PMA sublayer.

6. The OLT of claim 5, further comprising an optical receiver coupled to the optical fiber via the optical port, wherein the optical receiver is configured to receive analog optical signals from the HFC node via the optical fiber.

7. A coaxial line terminal (CLT) comprising:
an electrical transmitter; and
an electrical port coupled to the electrical transmitter, wherein the electrical port is configured to couple to a coaxial network unit (CNU) via an electrical cable, and
wherein the electrical transmitter is configured to transmit radio frequency (RF) signals to the CNU via the electrical cable.

8. The CLT of claim 7, further comprising a processor coupled to the electrical transmitter, wherein the processor comprises or is configured to execute an Ethernet passive optical network (EPON) media access control (MAC) layer configured to compose frames destined for the CNU, wherein the EPON MAC layer comprises:
a logical link control (LLC) sublayer;
a multipoint control protocol (MPCP) sublayer located logically under the LLC sublayer; and
a MAC sublayer located logically under the MPCP sublayer.

9. The CLT of claim 8, wherein the processor further comprises or is configured to execute:
a reconciliation sublayer (RS) located logically under the MAC sublayer; and
a 10 Gigabit Media Independent Interface (XGMII) located logically under the RS.

10. The CLT of claim 9, wherein the processor further comprises or is configured to execute a physical (PHY) layer also configured to compose the frames destined for the HFC node, wherein the PHY layer comprises:
a coax convergence sublayer;
a coax framing sublayer located logically under the coax convergence sublayer;
a coax coding sublayer located logically under the coax framing sublayer; and
a coax modulation sublayer located logically under the coax coding sublayer.

11. The CLT of claim 10, wherein the OLT further comprises:
an optical transmitter; and
an optical port coupled to the optical transmitter,
wherein the optical port is configured to couple to an optical network unit (ONU) via an optical fiber, and
wherein the optical transmitter is configured to transmit digital optical signals to the ONU via the optical fiber.

12. The CLT of claim 11, wherein the processor further comprises or is configured to execute an Ethernet passive optical network (EPON) MAC layer configured to compose second frames destined for the ONU, wherein the EPON MAC layer comprises:
a second EPON MPCP sublayer; and
a second Ethernet MAC sublayer located logically under the second EPON MPCP sublayer.

13. A method comprising:
identifying a passive optical network (PON) optical line terminal (OLT); and
adding a PON over coax (PoC) line card to the OLT so that the OLT communicates with optical network units (ONUs) within the PON and so that the OLT communicates with a hybrid fiber coaxial (HFC) node and coaxial network units (CNUs) within the PoC network via amplitude modulated (AM) signals.

14. The method of claim 13, wherein the OLT comprises:
an optical transmitter; and
an optical port coupled to the optical transmitter,
wherein the optical port is configured to couple to the ONUs via an optical fiber,
wherein the optical transmitter is configured to transmit digital optical signals to the ONU via the optical fiber,
wherein the PoC line card comprises:
an optical transmitter; and
an optical port coupled to the optical transmitter, wherein the optical port is configured to couple to the HFC node via an optical fiber, and
wherein the optical transmitter is configured to transmit the AM signals to the HFC node via the optical fiber.

15. The method of claim 14, further comprising a processor coupled to the optical transmitter, wherein the processor comprises or is configured to execute a PoC media access control (MAC) layer configured to compose frames destined for the HFC node, wherein the PoC MAC layer comprises:
a PON multipoint control protocol (MPCP) sublayer;
a MAC sublayer located logically under the PON MPCP sublayer; and
a PON reconciliation sublayer (RS) located logically under the MAC sublayer.

16. The method of claim 15, wherein the processor further comprises or is configured to execute a physical (PHY) layer also configured to compose the frames destined for the HFC node, wherein the PHY layer comprises:
a physical coding sublayer (PCS);
a physical-medium-attachment (PMA) sublayer located logically under the PCS; and
a physical medium dependent (PMD) sublayer located logically under the PMA sublayer.

17. The method of claim 16, wherein the processor further comprises or is configured to execute a PON MAC layer configured to compose second frames destined for the ONU, wherein the PON MAC layer comprises a second PON MPCP sublayer and a second Ethernet MAC sublayer located logically under the second PON MPCP sublayer, wherein the processor further comprises or is configured to execute a second PHY layer also configured to compose the second frames destined for the ONU, and wherein the second PHY layer comprises:
a second PCS;
a second PMA sublayer located logically under the second PCS; and
a second PMD sublayer located logically under the second PMA sublayer.

18. The method of claim 13, wherein the OLT comprises:
an optical transmitter; and
an optical port coupled to the optical transmitter,
wherein the optical port is configured to couple to the ONUs via an optical fiber,
wherein the optical transmitter is configured to transmit digital optical signals to the ONU via the optical fiber,
wherein the PoC line card comprises:
an electrical transmitter; and
an electrical port coupled to the electrical transmitter, wherein the electrical port is configured to couple to a coaxial network unit (CNU) via an electrical cable, and
wherein the electrical transmitter is configured to transmit radio frequency (RF) signals to the CNU via the electrical cable.

19. The method of claim 18, further comprising a processor coupled to the electrical transmitter, wherein the processor comprises or is configured to execute a PON media access control (MAC) layer configured to compose frames destined for the CNU, wherein the PON MAC layer comprises:
a logical link control (LLC) sublayer;
a multipoint control protocol (MPCP) sublayer located logically under the LLC sublayer; and
a MAC sublayer located logically under the MPCP sublayer.

20. The method of claim 19, wherein the processor further comprises or is configured to execute:
a reconciliation sublayer (RS) located logically under the MAC sublayer; and
a 10 Gigabit Media Independent Interface (XGMII) located logically under the RS, and
wherein the processor further comprises or is configured to execute a physical (PHY) layer also configured to compose the frames destined for the HFC node, wherein the PHY layer comprises:
a coax convergence sublayer;
a coax framing sublayer located logically under the coax convergence sublayer;
a coax coding sublayer located logically under the coax framing sublayer; and
a coax modulation sublayer located logically under the coax coding sublayer.
